(19) United States
(12) Patent Application Publication
(10) Pub. No.: US 2010/0131321 A1
(43) Pub. Date: May 27, 2010

(54) FAIR-SHARE LOGIC IN SUPPLY CHAIN MANAGEMENT SYSTEMS

(75) Inventors: Markus O. Riepp, Reilingen/Baden-Wuerttemberg (DE); Thomas B. Dehoust, Walldorf/Baden-Wuerttemberg (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(73) Assignee: SAP AG, Walldorf (DE)

(21) Appl. No.: 12/275,956

(22) Filed: Nov. 21, 2008

(51) Int. Cl. G06F 9/46

(52) U.S. Cl. 705/8

(57) ABSTRACT

A subset of demands to fair-share is identified from a group of demands. An artificial demand is created to represent a total demand quantity based on the subset of demands. The artificial demand is fulfilled to determine an available quantity for satisfying the artificial demand. The quantity demanded for each demand in the subset is reduced to fair-share the available quantity.

### FIELD

Embodiments described herein relate to supply chain management and more particularly to the sharing of resources to fulfill multiple demands in a supply chain environment.

### BACKGROUND

Organizations increasingly find that they must rely on effective supply chains, or networks, to successfully compete in the global market in a networked economy. Supply chain management (SCM), as the name implies, involves the management of goods, services, and/or other materials as they flow along supply chains from, for example, suppliers to customers.

Capable-to-Match, or CTM, offered by SAP AG of Walldorf, Germany is an example of a supply chain management function that can be used to enhance multi-site supply chain planning strategies. A CTM engine, or similar engine, is capable of performing a check of production capacities and transportation capabilities. CTM grades and works out multi-site production processes using time-dependent process parameters such as yields and process times. To exploit production capabilities to the maximum, a capacity check is performed down to the operational level. Planning strategies control the sequences of supply consumption and multi-level Bills of Materials (BOMs).

It is known to have simultaneous fulfillment of demands in an SCM system that has a global view of all demands. Systems and/or engines having only a local view process demands one after the other. In other words, traditional supply chain management components and/or products that have a local view cannot consider the needs of multiple demands when fulfilling a single demand. Thus, while supply chain management components and products having a global view may be able to fair-share available supplies and/or stock to fulfill a plurality of demands, systems and/or components that have only a local view do not have the ability to fair-share available quantities of stock. Thus, in various existing systems, the sequence of processing demands is such that demands that are earliest in time or have the earliest due dates will consume available stock before, and without regard to, demands that are received later in time or have later due dates. As a result, later-in-time demands may not be fulfilled if all available stock is consumed by earlier-in-time demands.

### SUMMARY OF THE DESCRIPTION

A system and method for fair-sharing in a supply chain management environment is described. A subset of demands is identified from a group of demands to fair-share. An artificial demand is created to represent a total demand quantity based on a subset of demands. The artificial demand is fulfilled to determine an available quantity that satisfies the artificial demand. The quantity demanded for each demand in the subset is reduced to fair-share the available quantity.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a flow diagram of operation in a system according to various embodiments.

### DETAILED DESCRIPTION

As provided herein, methods, apparatuses, and systems enable fair-sharing to fulfill demands in a supply chain management (SCM) environment. In some embodiments, an SCM system, or a component thereof, has a local view of demands. As used herein, a “demand” refers to any type of demand or request, whether from a customer or other entity, which requests a desired quantity of a given good, product, or service. For purposes of clarity in the discussion herein, goods, products and/or services that are on hand and available are referred to herein as “stock.” A demand may include a due date for fulfillment and a priority (or priority level). “Fair-sharing,” as used herein, refers to a process of allocating an available quantity of stock among a plurality of demands. Stock may be stored or located, for example, in a warehouse or other place of storage. In some embodiments, stock may be stored and/or located in more than one location. “Fulfilling” demands refers to satisfying orders (e.g., from a customer) for a demanded quantity of stock. Fulfillment may be achieved, for example, by delivery of the demanded quantity or by some other means such as, for example, establishing a customer order in the system, verifying the order, confirming the order, processing the order, etc.

Various embodiments described herein are described with reference to a CTM engine in a supply chain management (SCM) system environment. However, embodiments are not limited to a specific engine or component or system. In other words, other systems, engines, components, etc. may be used in various embodiments. The CTM engine described herein fulfills demands in sequence, one after the other, starting with the earliest demand (e.g., earliest due date, earliest receipt, etc.). After the earliest demand has been fulfilled, the next earliest demand is fulfilled, and so on.

As an example to illustrate a traditional demand fulfillment model, 3 customer orders (A, B, C) might be received by an engine (e.g., a CTM engine), each requesting/demanding a quantity of stock. The 3 customer orders each have a due date, for example, Jan. 1, 2008 (A), Jan. 2, 2008 (B) and Jan. 3, 2008 (C), respectively. The customer orders are prioritized based on their due dates. Thus, according to the given priorities, the CTM engine fulfills the demands in the sequence: A, B and C.

Continuing with the example, suppose that customer order A includes a demand for a quantity of 100, customer B's order includes a demand for a quantity of 100, while customer C's order also includes a demand for a quantity of 100. If the total stock available is a quantity of 150, then using traditional priority-driven demand fulfillment, customer order A will be fulfilled completely (i.e., the demand of 100 is fully satisfied). Customer order B can be partially fulfilled with the remaining stock (i.e., quantity of 50 out of demanded quantity of 100 can be satisfied). Customer order C, meanwhile, cannot be fulfilled at all given that all available stock was consumed by customer orders A and B.

By way of further explanation, the CTM engine may “fulfill” customer order A by creating a planned order in the SCM system. This planned order may create a dependent demand that is satisfied by another planned order and a transport of stock from one location to another location. This is an example of a typical CTM engine-generated production plan for the fulfillment of a demand, which arises from a constrained supply chain model having finite resources, lot size restrictions, and various validities of sources of supply, etc. In other words, at least these factors are considered by the CTM engine during plan generation.

So, as discussed above, after order A has been fulfilled (completely), the CTM engine might proceed to fulfill the second customer order B by a creating another planned order. This planned order may create another dependent demand which could be satisfied by a transport of stock to another location. Given that the customer order A has already consumed a quantity of 100, the available stock at the location (having been reduced to 50 from 150) is now fully consumed by customer order B. Finally, the CTM engine attempts to fulfill the third customer order C. However, because of capacity or stock restrictions in the model (i.e., stock has already been exhausted by customer orders A and B), there is not stock available to fulfill customer order C and thus the CTM engine fails to fulfill customer order C.

Using a fair-share model, as described herein, all orders in the above example should be fulfilled equally by the CTM engine, despite the fact that orders are filled one after the other (i.e., priority driven). Applying the fair-share technique described herein to the example above, all three of the demands (customer orders A, B and C) should get a quantity of 50 each, instead of 100 for A, 50 for B and zero for C. The CTM engine described herein has the ability to equally allocate the available quantity among the three customer orders/demands despite the fact that the CTM engine does not have an inherently global view of demands to determine that a quantity of 50 per demand is possible or perhaps preferred in a fair-share situation.

To fair-share customer orders, an artificial or “fair-share” order is generated by the CTM engine, the artificial order representing a sum of primary demand quantities for a set of customer orders. In other words, given the three customer orders from the example above, the CTM engine creates an artificial order for a quantity of 300, representing a summation or total quantity of each of the three customer orders. The CTM engine proceeds to “fulfill” this order. Thus, in various embodiments, a planned order is made for the quantity of 300, and the stock is checked to determine an available quantity. In response to the planned order, the CTM engine determines that a quantity of 150 of the stock is available to fulfill the artificial order.

In various embodiments, the artificial order is fulfilled before any other demands received by the CTM engine are fulfilled (e.g., customer orders A, B, C). Once the artificial demand has been satisfied, and the available quantity (up to the total demanded quantity) has been determined, the CTM engine may assign an equal quantity from the available quantity to each of the customer demands. In some embodiments, the available quantity can be allocated and/or shared on an equal percentage basis for each of the customer orders. In other words, each of the customer orders (A, B, and C) in the example will have their demand quantities reduced to equal 50. However, in other embodiments, the available quantity may be divided and shared among the three customer orders on some other basis. Thus, the quantity demanded for each of the demands is reduced to accommodate the fair-share allocations. In this way, each of the demands will be fulfilled on the reduced basis.

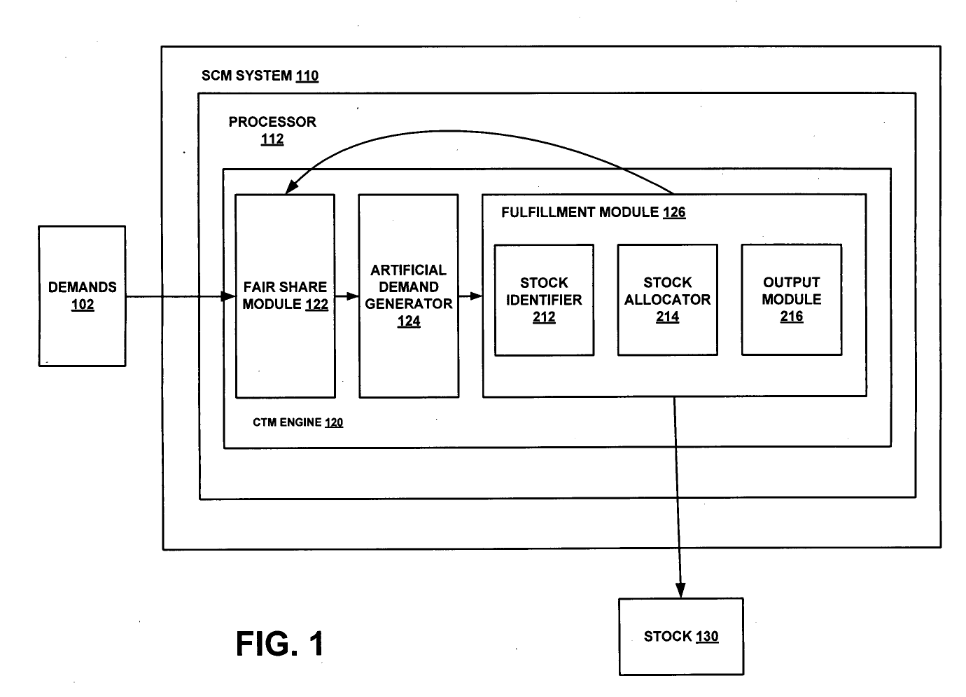

FIG. 1 is a block diagram illustrating a system according to various embodiments. Demands 102 are processed by SCM system 110. SCM system 110 includes a processor 112. While SCM system 110 is shown as a single entity in FIG. 1, SCM system 110 could be distributed among multiple entities in various embodiments. Likewise, processor 112 and/or the functions embodied by processor 112, including CTM engine 120 could also be distributed among multiple processors or processing units in other embodiments. Demands 102 are received by SCM system 110 and CTM engine 120 processes demands 102. In particular, fair-share module 122 receives the demands 102 and identifies a subset of the demands to fair-share. In various embodiments, demands 102 are received in succession, one after the other, while in other embodiments, demands 102 are received together as a group. Fair-share module 122 can identify a subset of demands based on a variety of factors including, but not limited to, priority, location, period during which the total available quantity remains unchanged, etc.

Once the subset of demands has been identified for fair-sharing, an artificial demand generator 124 creates an artificial demand to represent the total quantity demanded among the subset of demands. In other words, if there were, for example, four demands in the subset of demands, each demanding a quantity of 100, then the artificial demand generator would create an artificial demand of 400, representing the total quantity demanded by summing each of the demand quantities in the subset of demands.

Fulfillment module 126 receives the artificial demand generated by artificial demand generator 124 and fulfills the artificial demand to determine an available quantity that satisfies the artificial demand. For example, fulfillment module 126 makes an inquiry to determine how much stock 130 is available to satisfy/fulfill the artificial demand. Fulfillment module 126 may simply send a request for information in some embodiments to determine stock availability. In other embodiments, fulfillment module 126 generates a planned order which causes existing system mechanisms to take steps to fulfill the order including determining how much stock 130 is available. Once fulfillment module 126 has fulfilled the artificial demand (e.g., at least by determining how much stock is available—up to the total demanded quantity), fulfillment module 126 informs fair-share module 122 of the available quantity.

After fair-share module 122 has received information regarding the available quantity, as determined by fulfillment module 126, the artificial demand may be deleted, retired, etc. from CTM engine 120. Regardless, in various embodiments, the fulfillment of an artificial demand does not induce an actual transport of stock or have any other physical effects on the supply chain, in part because the artificial demand will have no shipment or delivery destination (or it may have an artificial destination that is recognized by CTM engine 120 as being an artificial demand).

Once fair-share module 122 has information regarding the available quantity of stock 130, fair-share module 122 can calculate a reduced quantity to allocate to each of the demands in the subset of demands to be fair-shared. The formula or algorithm for allocating the available quantity of stock among the demands in the subset can be varied in different embodiments. However, in some embodiments, fair-share module 122 divides the available quantity of stock equally, on a percentage basis, among each of the demands in the subset. Thus, if there are four demands, each for a quantity of 100 and the total available quantity is 300, fair-share module 122 would allocate a quantity of 75 to each of the demands in the subset. In this way, each of the demands is reduced by a quantity of 25.

In some embodiments, fair-share module 122 may divide the available quantity of stock on something other than an equal percentage basis. For example, fair-share module 122 may divide stock equally among demands in the subset on a strict basis. Thus, if there are four demands in the subset, three of which demand a quantity of 100 while the fourth demand is for a quantity of 200, rather than dividing the available quantity on a percentage basis, fair-share module may simply allocate an equal quantity to each of the demands (e.g., each demand gets an allocation of 75).

Fulfillment module 126 receives demands (e.g., from an artificial demand generator) for various quantities of stock. For a particular artificial demand, a stock identifier 212 identifies available stock and determines a quantity of available stock. The availability of stock may include availability at only one location or it may include availability at a combination of multiple locations. Stock allocator 214 allocates available stock to satisfy the artificial demand. If sufficient stock to satisfy the artificial demand is unavailable, stock allocator 214 may allocate the maximum stock available to the artificial demand. In some embodiments, stock allocator 214 may include various constraints that limit the available stock for allocation to something less than the absolute physical quantity of available stock (e.g., to maintain a supply or buffer of stock, etc.).

Once stock has been identified and allocated for the artificial demand, output module 216 sends the information regarding the available quantity of stock to the fair-share module (e.g., fair-share module 122 of FIG. 1). The fair-share module can then determine how to allocate the available quantity of stock among the demands in the identified subset.

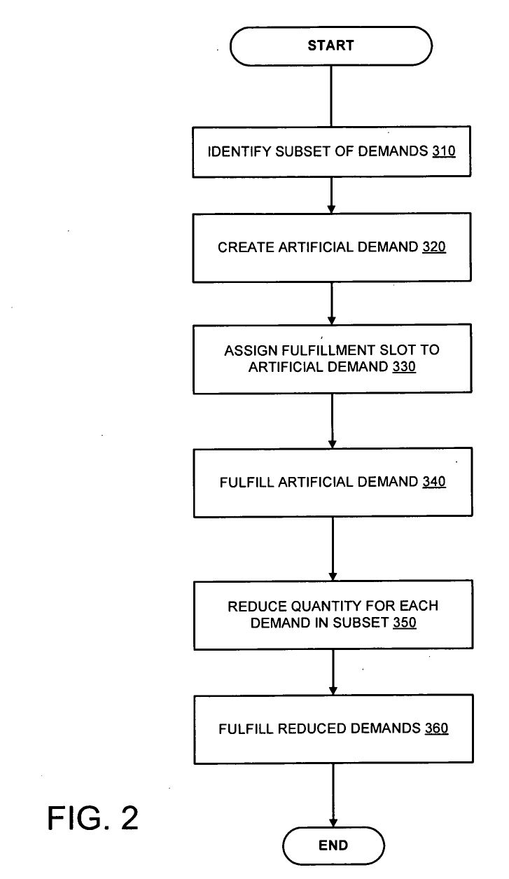

FIG. 2 is a flow diagram of operation in a system according to various embodiments. In a supply chain management environment, a subset of demands to be fair-shared is identified from a group of demands 310. The subset of demands could encompass all received demands in some embodiments. The quantity demanded for each demand in the subset is added together to determine a total quantity demanded for the subset. An artificial demand is created 320 based on the total quantity demanded for the subset. For example, if there are four demands in the subset, each demanding a quantity of 100, then the artificial demand would be created for a quantity of 400.

The artificial demand is assigned a fulfillment slot that is earlier in time than any other demand in the subset 330. In this way, the artificial demand can be processed before any of the demands in the subset. The artificial demand is then fulfilled 340, the result of which is knowledge of the quantity (up to the artificial demand quantity) of stock available for fulfilling demands. Given that the artificial demand is not an actual demand, fulfillment of the artificial demand does not necessarily result in the actual transport and/or delivery of stock. However, in some embodiments, the artificial demand may serve as an indicator to the SCM system of an impending transport or delivery of stock. Thus, the SCM system, in some embodiments, could take some action (e.g., movement of stock, etc.) in preparation for fulfilling the actual demands associated with the subset.

Given the knowledge of the available quantity of stock, the quantity for each demand in the subset is reduced 350 based on fair-share calculations. Thus, each of the demands in the subset are fulfilled equally (e.g., on a percentage basis, strict basis, etc.) or nearly equally on the reduced basis 360.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions. For example, embodiments of the invention may be downloaded as a computer program which may be transferred from a memory on a remote computer (e.g., a server) to a memory on a requesting computer (e.g., a client).

Various components described herein may be a means for performing the functions described herein. Each component described herein includes software, hardware, or a combination of these. The operations and functions described herein can be implemented as software modules, hardware modules, special-purpose hardware (e.g., application specific hardware, application specific integrated circuits (ASICs), digital signal processors (DSPs), etc.), embedded controllers, hardwired circuitry, etc.

Aside from what is described herein, various modifications may be made to the disclosed embodiments and implementations of the invention without departing from their scope. Therefore, the illustrations and examples herein should be construed in an illustrative, and not a restrictive sense.

What is claimed is:

1. A method associated with a computer, the method comprising:
identifying from a group of demands a subset of demands to fair-share;
creating an artificial demand to represent a total demand quantity based on the subset of demands;
fulfilling the artificial demand to determine an available quantity to satisfy the artificial demand; and
reducing the quantity demanded for each demand in the subset to fair-share the available quantity.

2. The method of claim 1, further comprising:
assigning the artificial demand a fulfillment slot that is earlier in time than any other demand in the subset.

3. The method of claim 1, wherein fulfilling the artificial demand comprises:
identifying available stock;
allocating stock to satisfy the artificial demand; and
providing an indication of the quantity of stock allocated.

4. The method of claim 1, wherein reducing the quantity demanded comprises:
allocating the available quantity among all demands of the subset.

5. The method of claim 4, wherein allocating the available quantity comprises:
allotting the available quantity among the demands of the subset on an equal percentage basis.

6. The method of claim 1, further comprising:
fulfilling the reduced demands.

7. The method of claim 1, further comprising:
deleting the artificial demand subsequent to determining the available quantity.

8. A machine accessible storage medium containing instructions that, when executed, cause a machine to:
identify from a group of demands a subset of demands to fair-share;
create an artificial demand to represent a total demand quantity based on the subset of demands;
fulfill the artificial demand to determine an available quantity to satisfy the artificial demand; and
reduce the quantity demanded for each demand in the subset to fair-share the available quantity.

9. The machine accessible storage medium of claim 8, wherein the instructions further comprise instructions that cause the machine to:
assign the artificial demand a fulfillment slot that is earlier in time than any other demand in the subset.

10. The machine accessible storage medium of claim 8, wherein the instructions causing the machine to fulfill the artificial demand cause the machine to:
identify available stock;
allocate stock to satisfy the artificial demand; and
provide an indication of the quantity of stock allocated.

11. The machine accessible storage medium of claim 8, wherein the instructions causing the machine to reduce the quantity demanded cause the machine to:
allocate the available quantity among all demands of the subset.

12. The machine accessible storage medium of claim 11, wherein the instructions causing the machine to allocate the available quantity cause the machine to:
allot the available quantity among the demands of the subset on an equal percentage basis.

13. The machine accessible storage medium of claim 8, wherein the instructions further comprise instructions to cause the machine to:
fulfill the reduced demands.

14. The machine accessible storage medium of claim 8, wherein the instructions further comprise instructions to cause the machine to:
delete the artificial demand subsequent to determining the available quantity.

15. A system, comprising:
a fair-share module to identify from a group of demands a subset of demands to fair-share;
an artificial demand generator to create an artificial demand to represent a total demand quantity based on the subset of demands;
a fulfillment module to fulfill the artificial demand to determine an available quantity to satisfy the artificial demand; and
the fair-share module further to reduce the quantity demanded for each demand in the subset to fair-share the available quantity.

16. The system of claim 15, further comprising:
the artificial demand generator to assign the artificial demand a fulfillment slot that is earlier in time than any other demand in the subset.

17. The system of claim 15, wherein the fulfillment module further comprises:
a stock identifier to identify available stock;
a stock allocator allocate stock to satisfy the artificial demand; and
an output module to provide an indication of the quantity of stock allocated.

18. The system of claim 15, wherein the fair-share module allocates the available quantity among all demands of the subset.

19. The system of claim 18, wherein the fair-share allots the available quantity among the demands of the subset on an equal percentage basis.

20. The system of claim 15, wherein the fulfillment module deletes the artificial demand subsequent to determining the available quantity.
